(19) United States
(12) Patent Application Publication
(10) Pub. No.: US 2002/0126951 A1
(43) Pub. Date: Sep. 12, 2002

(54) Optical converter flex assemblies

(76) Inventors: Robert A. Sutherland, Los Gatos, CA (US); James S. Sacks, Sunnyvale, CA (US); Eric B. Grann, San Ramon, CA (US); Kenneth R. Herrity, Milpitas, CA (US); Jeffrey A. Griffis, Redwood City, CA (US); Frank W. Jacobson JR., Antioch, CA (US)

Correspondence Address: Bruce H. Johnsonbaugh, Eckhoff, Hoppe, Slick, Mitchell & Anderson, Suite 3125, 333 Market Street, San Francisco, CA, 94105, US

(21) Appl. No.: 09/808,666

(22) Filed: Mar. 14, 2001

Related U.S. Application Data
(63) Continuation-in-part of application No. 09/805,514, filed on Mar. 12, 2001.

(51) Int. Cl. G02B 6/28; G02B 6/42

(52) U.S. Cl. 385/24; 385/88

(57) ABSTRACT

Optical to electrical and electrical to optical conversion assemblies provide precise and stable alignment, low loss, unperturbed electrical transmission and high thermal conductivity. Mechanically isolating the ceramic substrate of the conversion assembly relative to the surrounding structures enables good long-term optical alignment. Electrical transmission line connections to and from the optical conversion circuits on the ceramic substrates are made via flexible circuit board designs. The alignment of the components on the substrate relative to the plastic optics is thus preserved. The flexible circuit board includes a cross hatched ground layer, which relieves portions of the metallization below the signal layer and yet is able to maintain the desired transmission line properties. Electrical to optical conversion circuits are provided where the transmission of the electrical signals to the converter circuits is accomplished with minimal loss and with good signal integrity.

### CROSS-REFERENCE TO RELATED APPLICATION

This application is a continuation-in-part of U.S. patent application Ser. No. ______, titled “Optical Wavelength Division Multiplexer and/or Demultiplexer Mounted in a Pluggable Module,” filed on Mar. 12, 2001, and incorporated herein by reference.

### BACKGROUND OF THE INVENTION

1. Field of the Invention

The present invention relates to optical to electrical and electrical to optical conversion assemblies used in fiber optic communication, and more specifically, it relates to designs for isolating the conversion assemblies from forces that could cause misalignment of the optical and electrical components and for improving the performance of the conversion assemblies.

### DESCRIPTION OF RELATED ART

Optical to Electrical (O to E) and Electrical to Optical (E to O) conversion assemblies often require precise and stable alignment, low loss, unperturbed electrical transmission and high thermal conductivity. A variety of methodologies have been proposed to achieve these results.

Most O to E and E to O assemblies are much simpler with a single laser or single detector in the assembly. Typically these single element assemblies are enclosed in a small cylindrical metal frame with a small glass lens opening on one end and electrical leads out the other end. The electrical leads for this type of assembly are soldered directly to a rigid printed circuit board. This type of design provides that the axis on which the optical signal is propagated is perpendicular to the assembly lens as well as the detector or laser surface and the axis is also parallel to the direction of force used to connect optical fibers to these assemblies. The result of such as design is that it can tolerate sizable amounts of force in connecting optical fibers with little or no optical misalignment.

It is desirable to provide a more complicated design that described in the prior art, and which includes multiple lasers or detectors in a given assembly. Due to its added complexity, such a design would be more sensitive to optical misalignment. It would be advantageous if, unlike most current O to E or E to O assemblies, the direction of the optic fiber connecting force could be perpendicular to the optical signal emanating from the lasers or impinging on the detectors. Such a design would require a greater degree of mechanical isolation of the O to E or E to O substrate from any forces that could act upon it. The designs described below achieve these results.

### SUMMARY OF THE INVENTION

It is an object of the present invention to provide optical to electrical and electrical to optical conversion assemblies that achieve mechanical isolation from surrounding structures of the substrate upon which the optics and optic conversion circuits are attached.

It is a further object to provide such isolation through the use of a flexible circuit.

It is another object of the invention to provide high speed circuitry for use in O to E and E to O conversion assemblies.

Another object of the invention is to provide means for achieving low loss transmission of electrical signals propagating on flexible circuits used in O to E and E to O conversion assemblies.

Still another object is to provide methods for fabricating a ceramic substrate for use in an optical to electrical or electrical to optical conversion assembly.

Another object is to provide a method of fabricating a flexible high speed transmission line for use in an optical to electrical or electrical to optical conversion assembly.

These and other objects will be apparent to those skilled in the art based on the teachings herein.

The invention is Optical to Electrical (O to E) and Electrical to Optical (E to O) conversion assemblies that provide precise and stable alignment, low loss, unperturbed electrical transmission and high thermal conductivity.

Good long-term optical alignment is achieved by providing mechanical isolation of a ceramic substrate relative to the optical components. The plastic optical portion of the conversion assemblies is rigidly attached directly to a housing. The ceramic with its associated circuitry is also rigidly attached to the plastic optic. Electrical transmission line connections to and from the optical conversion circuits on the ceramic substrates are made via flexible circuit board designs. The alignment of the components on the substrate relative to the plastic optic is thus preserved.

The surfaces onto which the components are attached have a low coefficient of thermal expansion (CTE) by utilizing a ceramic substrate. Utilizing a ceramic substrate also provides a flat surface on which to mount optical conversion circuitry. Ceramic surfaces provide less than 0.003 inch per inch linear flatness. The ceramic also provides a highly conductive thermal path to remove heat from the electronic circuitry.

One ceramic design utilizes a thick film process to deposit metal on a ceramic substrate for attachment of the optical conversion circuits, routing of signals and gold bond wire attachment. Another ceramic design utilizes a copper clad ceramic substrate that undergoes a subtractive etch process and then is plated.

The O to E assembly connections are made via a gold bond wire from the top of the flexible circuit to the components on the ceramic substrate as well as to the gold pads on the ceramic substrate itself. The E to O assembly electrical connections are made using solder connections from the metal pads on the ceramic to vias on the flex circuit board.

Methods are provided for fabricating thick ceramic substrates and high speed flexible circuits. A proprietary system referred to by the trade name Z-Strate® is used for creation of copper clad ceramic boards.

A unique feature of the present design of the flexible circuit board is the cross hatch of the ground layer below the signal trace. Typically, a microstrip transmission line uses a solid ground plane. The cross-hatched design relieves portions of the metallization below the signal layer and yet is able to maintain the desired transmission line properties. Still another feature of the design of the flexible circuit board is the use of a liquid photo imageable (LPI) solder mask, which provides additional flexibility because it is less rigid than polyimide material and is not as thick.

The present invention provides Electrical to Optical (E to O) conversion circuits where the transmission of the electrical signals to the converter circuits is accomplished with minimal loss and with good signal integrity. Reducing signal loss is achieved by reducing reflections as well as by lowering absorptive loss. Preventing cross talk between adjacent signal lines, as well as reducing ringing and standing waves that result from signal reflections optimizes signal integrity.

Achieving good signal integrity and low signal loss typically requires creating a real transmission line impedance with the capacitive and inductive effects of the transmission line conductor cancelled out (i.e., no imaginary component to the transmission line impedance). In addition, optimal signal integrity and signal transmission requires that the source and load impedances presented to the transmission line match the impedance of the transmission line.

### BRIEF DESCRIPTION OF THE DRAWINGS

FIG. 1A shows the construction of a stripline flexible circuit board.

FIG. 1B shows the construction of a microstrip flexible circuit board

FIG. 2 shows the flexible transmission line stack up used for this design.

FIGS. 3 shows the simulation set up for the E to O 50 ohm transmission line design.

FIG. 4 shows simulation results for the 50 ohm transmission line and provides the amount of reflection with such a line.

FIG. 5 provides a Smith chart showing the amount of reflection with the transmission line terminated with 50 ohms.

FIG. 6 shows the isolation between adjacent traces.

FIG. 7 shows the O to E 75 ohm transmission line design simulation set-up.

FIG. 8 shows the amount of reflection with such a transmission line.

FIG. 9 provides the amount of reflection with a transmission line terminated with 75 ohms plotted on a Smith Chart.

FIG. 10 shows the isolation between adjacent traces for 75 ohm transmission lines.

FIG. 11 shows a view of a design for the cross hatch ground plane.

FIG. 12 shows a specific embodiment of an O to E assembly.

FIG. 13 shows an embodiment of the TX ceramic piece that is to be connected to the flexible circuit board of FIG. 12.

FIG. 14A shows the flexible circuit board connected to the ceramic piece.

FIG. 14B shows a top view of the plastic housing attached to the ceramic piece, which is attached to the flexible circuit board.

FIG. 14C shows a side view of the plastic housing attached to the ceramic piece, which is attached to the flexible circuit board.

FIG. 14D shows a perspective view of the plastic housing attached to the ceramic piece, which is attached to the flexible circuit board.

FIG. 15 shows an embodiment of the ceramic piece for use in an Rx assembly.

FIG. 16 shows an RX flex circuit.

FIG. 17A shows the RX assembly attached to the flexible circuit.

FIG. 17B shows a top view of a plastic pluggable module attached to a ceramic piece, which is attached to a flexible circuit.

FIG. 17C shows a side view of a plastic pluggable module attached to a ceramic piece, which is attached to a flexible circuit.

FIG. 17D shows a perspective view of a plastic pluggable module attached to a ceramic piece, which is attached to a flexible circuit.

FIG. 18 shows a schematic of the TX design that utilizes VCSELs in the 780 to 865 nm wavelength range.

### DETAILED DESCRIPTION OF THE INVENTION

An aspect of the present invention achieves good long-term optical alignment by providing mechanical isolation of a ceramic substrate relative to the optical components such as lenses. This is accomplished by rigidly attaching the plastic optical portion of the conversion assemblies directly to a housing. Examples of wavelength division multiplexers and/or demultiplexers that may be housed in the plastic optical portion are described in the parent application and in commonly owned U.S. Pat. No. 6,201,908, titled “Optical Wavelength Division Multiplexer/Demultiplexer Having Preformed Passively Aligned Optics,” incorporated herein by reference. The ceramic with its associated circuitry is also rigidly attached to the plastic optic. Electrical transmission line connections to and from the optical conversion circuits on the ceramic substrates are made via flexible circuit board designs. This flexible transmission line connection prevents any forces from acting on the ceramic and effectively mechanically isolates the substrate. Without any appreciable force applied to the ceramic, the alignment of the components on the substrate relative to the plastic optics is preserved.

This disclosure sometimes refers to embodiments of optical to electrical (O to E) conversion assemblies or circuits as O to E assemblies or RX Flex assemblies. Embodiments of electrical to optical (E to O) conversion assemblies or circuits are sometimes referred to as E to O Flex assemblies or as TX Flex assemblies.

The surfaces onto which the O to E components (such as PIN detector diodes), as well as E to O components (such as a vertical cavity surface emitting laser (VCSEL)), are attached should have a low coefficient of thermal expansion (CTE). This is beneficial because the alignment of the conversion circuitry to the optical components such as lenses will not be perturbed as the assembly undergoes temperature changes. The designs detailed below obtain low CTE performance by utilizing a ceramic substrate. Ceramics provide CTE values of less than 9E-6 of dimensional change per degree C. Utilizing a ceramic substrate also provides a flat surface on which to mount optical conversion circuitry. Ceramic surfaces provide less than 0.003 inch per inch linear flatness.

The designs detailed below achieve low loss and good signal integrity transmission using a flexible circuit board design that mounts to the ceramic substrate. These designs provide good electrical signal transmission as well as flexibility to provide mechanical isolation of the substrate.

Another key requirement of optical conversion circuitry is that of providing a highly conductive thermal path to remove heat from the electronic circuitry. Utilizing a ceramic substrate upon which the optical conversion circuitry is mounted provides this good thermal path. The designs described here could easily have utilized BeO, AIN, or Al₂O₃ as the ceramic substrate. Al₂O₃, while the worst in terms of thermal conductivity, is the least expensive and the most readily available. Although of the three ceramics Al₂O₃ is the least thermally conductive, it is still a very good thermal conductor with a nominal rating of 25 W/m K. The Al₂O₃ ceramic provides sufficient thermal conductivity for this particular application.

Designs

There are two different design methodologies that incorporate the benefits and attributes detailed above. One methodology utilizes a thick film process to deposit metal on a ceramic substrate for attachment of the optical conversion circuits, routing of signals and gold bond wire attachment. The other method utilizes a copper clad ceramic substrate that undergoes a subtractive etch process and then is plated.

In addition to the two different ceramic design approaches there is also a difference in the way the O to E assembly electrical connections are made from the flex circuit to the ceramic vs. the way these connections are made on the E to O assembly. The O to E assembly connections are made via a gold bond wire from the top of the flexible circuit to the components on the ceramic substrate as well as to the gold pads on the ceramic substrate itself. The E to O assembly electrical connections are made using solder connections from the metal pads on the ceramic to vias on the flex circuit board.

Construction of Thick Film Ceramic

The thick film ceramic is first created by obtaining sheets of Al₂O₃, which is lapped down to a thickness of 0.035 inches. The material is processed in panel form with multiple ceramic substrates being processed with each individual panel. After lapping the panels down to the proper thickness, holes are laser drilled in the ceramic.

After the ceramic panels are drilled, they are cleaned and pre-fired using a convection oven that slowly ramps the material up to 850 to 900 degrees C. After this initial preparation step the panels have a PdAg paste applied utilizing a screen-printing technique. This technique utilizes a fine mesh screen with an emulsion layer that has openings where the metal patterns are to be put down on the ceramic. The paste is pushed through the screen emulsion openings using a squeegee. The thickness of the emulsion determines the thickness of the metal paste that is applied.

After the first PdAg metal paste is applied, the ceramic panel is baked at 100 to 150 degrees C. to remove the solvents from the paste. The panel is then inspected and then run through another convection oven that slowly ramps the temperature to between 850 and 900 degrees C. to anneal the PdAg. After the panels are allowed to cool they are inspected and made ready for the next metal layer.

Gold is the next paste that is printed onto the panels. The printing, removal of solvents and annealing steps of placing gold pads and traces onto the ceramic surface is done in the same way that the PdAg metal layer was created.

After the PdAg and Au layers have been created, the panels that require thick film resistors are created. The resistors are created in much the same way that the metal layers were. A resistive paste is laid down on the ceramic surface in the required geometry and then baked and fired as with the metal layers.

After the metal layers and resistors have been laid down, the ceramic panels are cut into individual substrates using a diamond saw. The individual substrates are inspected and readied for flex circuit board attachment.

Construction Copper Clad Ceramics

A proprietary system is used for creation of copper clad boards. The material created using this process is commercially available and is referred to by the trade name Z-Strate®). Z-Strate®) is a registered trademark from the company Zecal. Zecal is located at 456 North Sanford Road Churchville, N.Y. 14428 USA. See also www.zecal.com. The processing steps given below come from the Z-Strate® documentation.

A computer-generated part drawing is prepared and used to program laser machining/profiling operations and to create photo tools for subsequent operations.

A blank ceramic panel is machined (usually by laser) to achieve precise configurations and, when several small parts are to be produced from one panel, to scribe the part edges into the panel for later separation. Frequently, precision assembly guides are also laser-drilled at this stage.

The surfaces of the panel are then prepared for electroless copper plating.

A thin layer of pure copper is electrolessly deposited over the entire surface on both sides of the panel and into all openings in the panel.

Photoresist is applied and imaged to define conductor patterns.

Copper patterns are electrolytically plated, simultaneously, onto all selected surfaces of the panel.

Photoresist is stripped off and the thin electroless layer of cooper is etched from between the patterns of electrolytically plated copper.

The substrate is fired at high temperature to strongly bond the copper to the ceramic.

The substrate is cleaned.

The copper is then plated using an electroless nickel process to a thickness of 100 micro inches.

The nickel-plated copper is then electrolytically plated with 50 to 60 micro inches of gold.

The substrate is then separated into individual parts.

Flex Board Construction

Optimal operation of optical to electrical (O to E) conversion circuits or electrical to optical (E to O) conversion circuits requires that the transmission of the electrical signals to and from the converter circuits be accomplished with minimal loss and with good signal integrity. Achieving low loss transmission of the electrical signals used in conjunction with these conversion circuits can be accomplished using transmission media such as coaxial cable, microstrip, or stripline in the 1 MHz to 20 GHz frequency range or via waveguides in the 500 MHz and higher frequency range. Reducing signal loss is achieved by reducing reflections as well as by lowering absorptive loss. Preventing cross talk between adjacent signal lines, as well as by reducing ringing and standing waves that result from signal reflections optimizes signal integrity.

Achieving good signal integrity and low signal loss typically requires creating a real transmission line impedance with the capacitive and inductive effects of the transmission line conductor cancelled out (i.e., no imaginary component to the transmission line impedance). In addition, optimal signal integrity and signal transmission requires that the source and load impedances presented to the transmission line match the impedance of the transmission line.

In addition to providing low loss and good signal integrity for the electrical signals, it is advantageous for the electrical signal transmission to be accomplished via a medium that provides mechanical flexibility. This flexibility allows the conversion circuitry to be mechanically isolated from other assemblies as well as to provide more options for mechanical layout and routing.

The electrical signal transmission to optical conversion circuits described below were designed to achieve low loss and good signal integrity as well as mechanical flexibility. The design was targeted for an application with signal frequencies greater than 1 MHz and less than 20 GHz. This frequency range prompted the examination of stripline and microstrip structures.

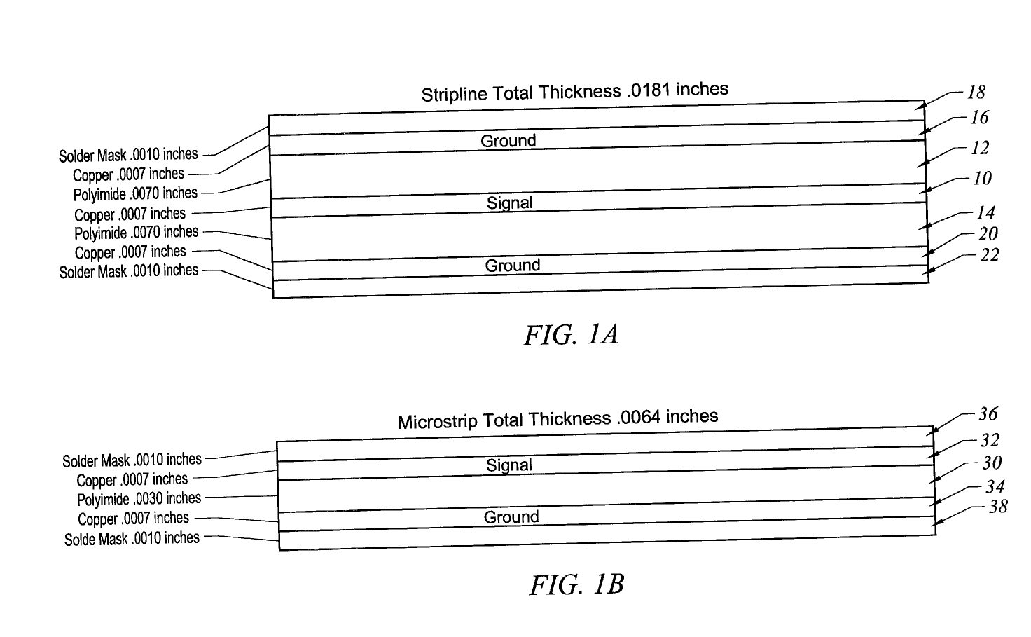

There are several unique features to this transmission line design that have been implemented in order to achieve maximum mechanical flexibility while obtaining good signal integrity and low loss. One of these features is the choice of a two-layer transmission line design for improved flexibility and lower fabrication cost. An examination of the needed stack up of a three layer transmission line (i.e., a stripline) versus that required for a two layer transmission line (i.e., a microstrip) shows why this is the case (See FIGS. 1A and 1B). The figures provides an example of the needed stack up for a 75 ohm transmission line using polyimide based circuit board material. FIG. 1A shows the construction of a stripline flexible circuit board. A copper layer 10 of 0.0007 inches is at the center of this construction, and is surrounded above and below with polyimide layers 12, 14, of 0.0070 inches. A copper layer 16 of 0.0007 inches is above the polyimide layer 12, and is covered with a solder mask 18. A copper layer 20 of 0.0007 inches is below the polyimide layer 14, and is covered with a solder mask 22. The limiting factor in deciding dielectric thickness is governed by the smallest width traces that can be fabricated with a volume manufacturing process, which in this case is 0.003 inches. FIG. 1B shows the construction of a microstrip flexible circuit board. A polyimide layer 30 of 0.0030 inches is covered above and below by copper layers 32, 34, which are covered by solder masks 36 and 38 respectively. As can be seen by comparing FIGS. 1A and 1B, a microstrip construction cuts the board thickness down by ⅓ while maintaining good transmission line properties.

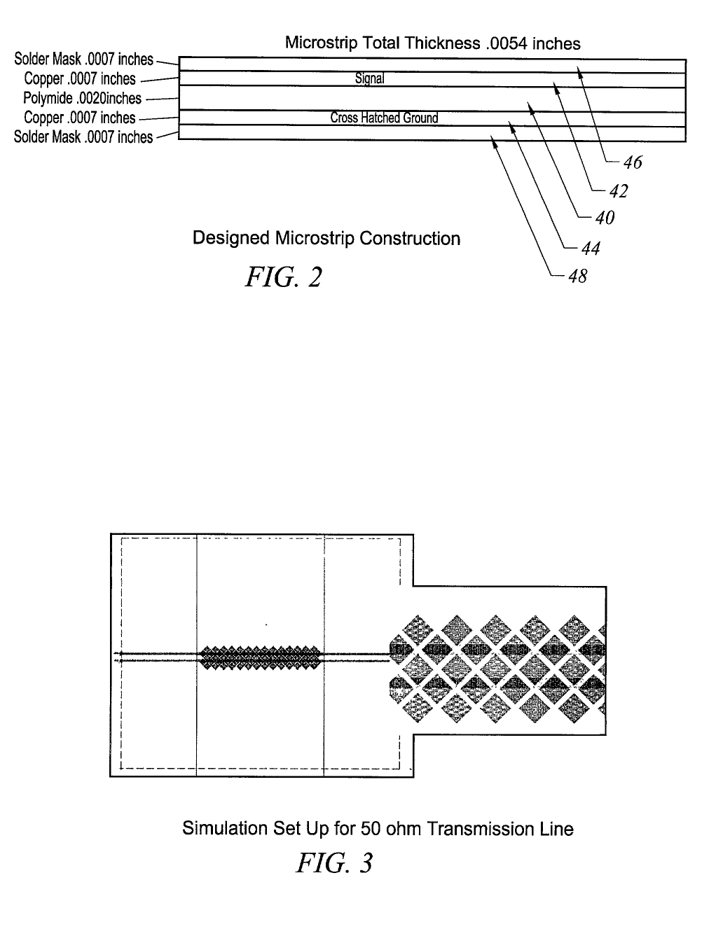

Another unique feature of the present design is the cross hatch of the ground layer below the signal trace. Typically, a microstrip transmission line uses a solid ground plane. The cross hatched design relieves portions of the metallization below the signal layer and yet is able to maintain the desired transmission line properties. There are two main reasons for using this cross hatched ground plane. Both reasons stem for the desire to make the transmission line as flexible as possible. The first is that the cross hatched ground plane raises the impedance of the transmission line for a given trace width. This design maintains a 75 ohm transmission line with a manufacturable 0.004 inch trace and a thin but readily available polyimide thickness of 0.002 inches. The transmission line is that much more flexible with a construction that is an additional 0.001 inch thinner. The fabricated transmission line circuit utilizing this layout is a mere 0.0054 inches thick. FIG. 2 shows the flexible transmission line stack up used for this design. It consists of a polyimide layer 40 of 0.0020 inches, copper layer 42 and 44, each of 0.0007 inches, and solder masks 46 and 48, each of 0.0007 inches. Copper layer 44 includes a cross hatched design. The other reason for utilizing a cross hatched ground is that the construction becomes more flexible by removal of additional copper from the ground plane without even changing the polyimide thickness. The flexibility of the design is therefore improved in two ways by using a cross hatched ground plane. It should be recognized by those skilled in the art that the layer thicknesses described herein can be modified without departing from the scope of the present invention.

Another feature of this design is the use of a liquid photo imageable (LPI) solder mask. The choices available for solder mask are a polyimide coverlay which is nominally 0.001 inch thick or LPI which as shown in FIG. 2 is nominally 0.0007 inches thick. The choice of LPI for the solder mask provides additional flexibility because it is less rigid than the polyimide material and it is not as thick.

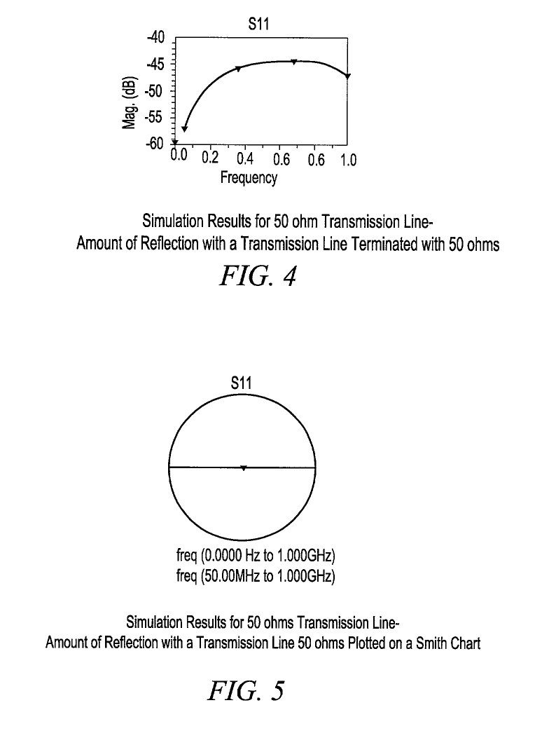

In order to achieve the desired impedances utilizing the construction shown in FIG. 2, simulations were run to determine the optimal cross hatch and line widths. The simulations were performed using a program called “Momentum” available from Agilent Technologies. This a 2½ D electromagnetic simulator. Two different impedance boards were designed. One was designed for a nominal impedance of 50 ohms and the other for a nominal impedance of 75 ohms. The crosshatch design and simulations for both designs are shown below in FIGS. 3 through 10.

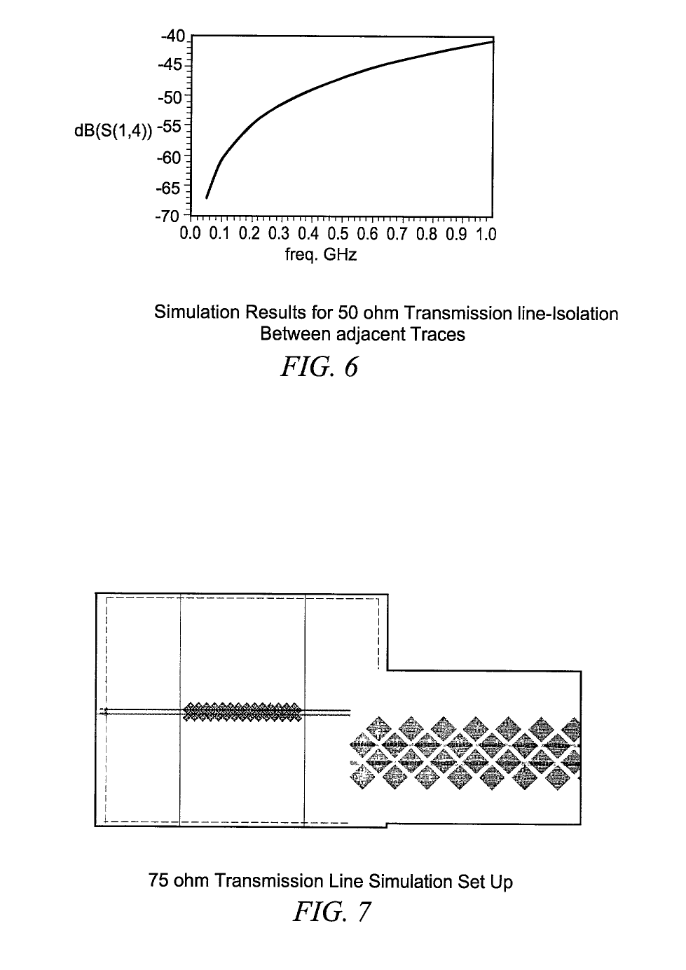

FIG. 3 shows a simulation set up for the 50 ohm transmission line design. FIG. shows simulation results for the 50 ohm transmission line and provides the amount of reflection with such a line. FIG. 5 provides a Smith chart showing the amount of reflection with a transmission line terminated with 50 ohms. FIG. 6 shows the isolation between adjacent traces.

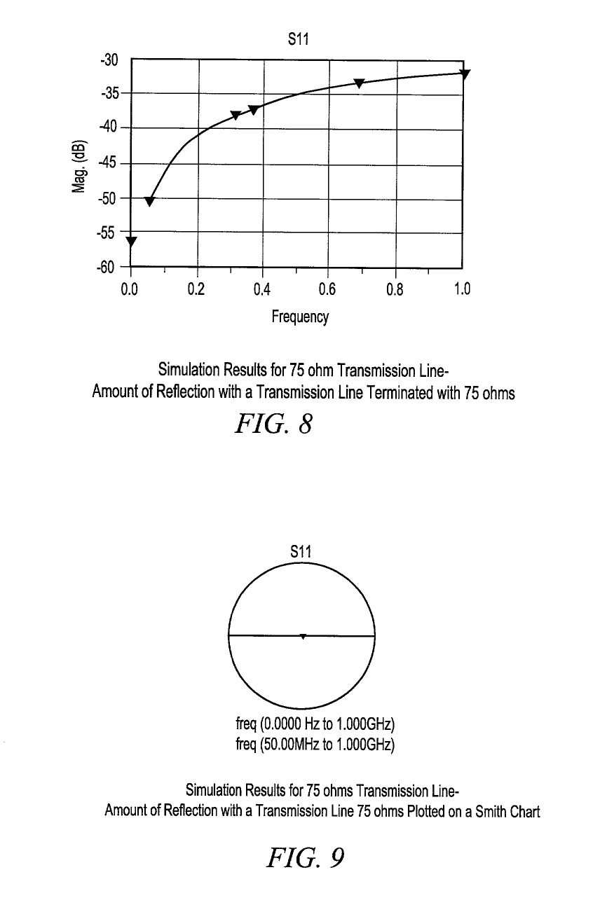

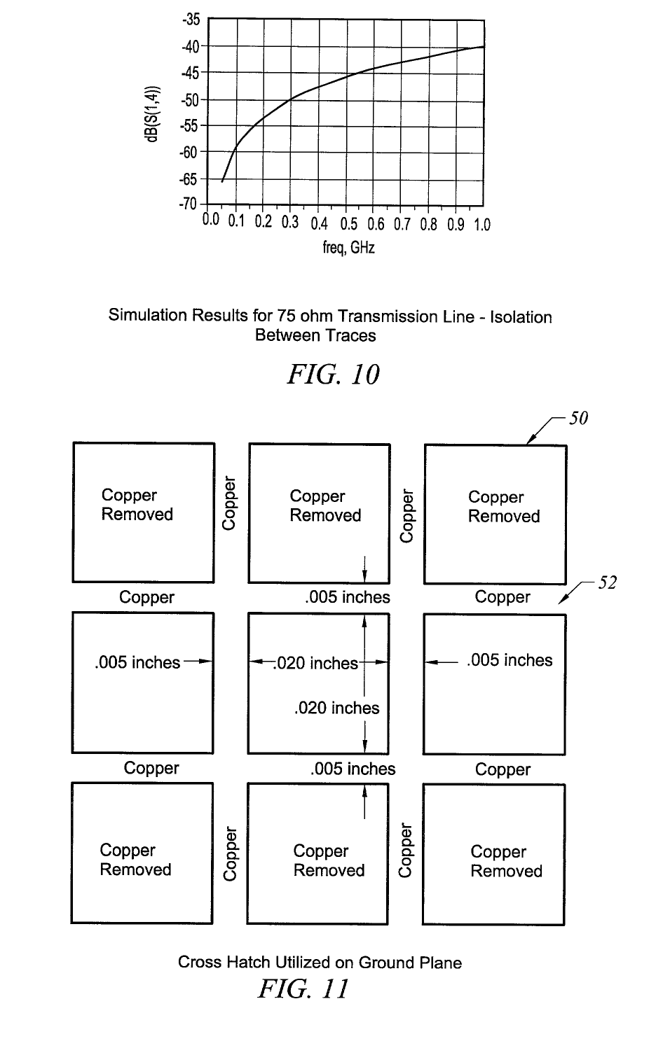

FIG. 7 shows the 75 ohm transmission line design set-up. FIG. 8 shows the amount of reflection with such a transmission line. FIG. 9 provides the amount of reflection with a transmission line terminated with 75 ohms plotted on a Smith Chart. FIG. 10 shows the isolation between adjacent traces for 75 ohm transmission lines.

The target application operates at a fundamental frequency of 78 MHz. Given this low frequency, the design can tolerate variation of +/−15% in the width of the traces and +/−10 in the thickness of the polyimide with acceptable performance. The methodology and the design is capable of operating well at much higher frequencies, potentially as high 10 GHz, depending on the amount of variation allowed in the trace widths and dielectric thickness as well as the needed performance. The cross hatched ground plane operated well in simulations up to 1 GHz as is seen in the plots. Higher frequencies will require a smaller cross hatch with less copper removed, with the extreme case requiring a solid ground plane.

Construction

The following describes the steps required to construct the flexible high speed transmission line for O to E and E to O circuits.

Sheets of 0.002 inch thick polyimide material with annealed copper on both sides are cut into 12 inch by 12 inch panels that will net out 20 boards for this particular design. Three panels are placed on top of each other and all of the vias and holes that are required on the flex circuit board are drilled. The holes are drilled such that the diameters of the holes are 0.004 to 0.005 inches wider than the required finished hole. This action completes the drill operation on a total of 60 flex boards.

The individual panels are then put in a plating bath to electroless plate Copper. This plating step provides a thin connection of copper through the vias connecting the two sides of the board. This step provides 30 to 40 micro inches of copper plating.

In order to strengthen the via connections an additional electroplated copper plating sequence is required. Accomplishing this plating requires that a layer of dry film photo resist is placed on both sides of the panel. Once this is done film with opaque pad areas where the vias are located is placed over the panel and the panel is then subjected to ultra violet light. The transparent areas of the film where there are no pads are subjected to this light. Exposure to the ultra violet light causes the exposed photo resist material to polymerize. This polymerization process causes the hydrocarbon chains of the photo resist in these areas to become long and strong and prevents them from dissolving when the panel is placed in a developer bath. Once the photo resist where the via pads are located has been removed in the developer bath the panel is placed in a copper plating bath where the exposed areas are electroplated with copper to a thickness of approximately 0.001 inches.

After electroplating of the copper onto the panel, the remaining photo resist is removed. Dry film photoresist is again applied to both sides of the panel. Negative image films of the copper traces and cross hatched ground are applied to both sides of the panel. The panel is again exposed to ultra violet light on both sides. The photoresist areas that are exposed to the light are polymerized and become resistant to the developer. The panel is again placed in the developer bath and the resist is removed from the areas where the copper is to be removed. Once this step is accomplished the panel is placed in an alkaline etching bath where the unwanted copper is removed from the panels. The remaining photoresist is then stripped away leaving copper only where traces and cross hatched ground are desired.

The panel is then coated with liquid photoimageable solder mask. The panel is coated with this liquid material and then placed in an oven at 170 to 180 degrees C. for 15 minutes. This dries the LPI material so that it is no longer sticky. Negative image film of the solder mask layers on the top and bottom of the board are placed against the panel and the panel is then exposed to ultra violet light. The areas exposed to the light are polymerized and become resistant to the developer. The panel is placed in a developer bath and the solder mask is removed from those areas of the board that were not exposed to the ultra violet light. The panel is then baked at 300 degrees C. for 1 hour to completely cure the solder mask layers.

After the solder mask has been successfully applied the exposed copper, the panels are plated using an electroless Nickel plating process. After the nickel is plated on top of the copper to a thickness of 100 to 200 micro inches the panels are plated with gold. One of the board designs requires that Gold bond wires be attached. This design requires the Gold be plated using an electroplating method. The gold in this case is plated to a level of between 40 and 60 micro inches. The second design does not require any bond wire attachment and so the gold plating for this design is applied using an electroless plating bath with the gold plated to a thickness of between 10 and 20 micro inches.

Once the gold plating is complete an acrylic adhesive film is applied to the back of the panel. This is adhesive is rolled onto the panel using rollers set to a temperature of 190 degrees F.

With the adhesive film successfully applied, the panel is then routed. This means that the panel is placed on a drill and route machine that cuts each individual board out of the panel.

The individual flex boards are then attached to the end application substrate. This completes the fabrication of the flexible transmission line circuit.

Flex to Ceramic Attachment

To attach the flex circuit boards to the ceramic, the flex circuit boards need to be properly registered to the ceramic substrate and clamped together using an assembly fixture. Pressure and temperature must be applied to cause the acrylic adhesive on the bottom of the flex circuit board to cure and form a solid bond between the ceramic substrate and the flex circuit board. In order to obtain a good bond the following conditions are needed: pressure of 35 PSI, temperature of 365 degrees F., and process time of 1 hour.

One of the design paths described here requires a soldered electrical connection from the flexible circuit board to the ceramic substrate once the flexible circuit board is glued to the ceramic substrate. This soldering process starts with depositing of fine grain solder paste utilizing a paste stencil in the area where the solder joints will be made. The paste is pushed down the vias holes to the metal surface of the ceramic substrate. The flex/ceramic assemblies are then sent through a convection oven where the solder melts and creates a fillet between the walls of the via and the metal surface of the ceramic substrate.

FIG. 11 shows a view of a design for the cross hatch ground plane. Copper has been removed from square areas 50 having dimensions of 0.020 by 0.020 inches and remains on the strips 52, which are 0.005 inches wide.

Active Component Placement and Bonding

Once the flexible circuit board has been attached to the ceramic substrate the assembly is populated with components and bonded. In the case of an E to O assembly, VCSEL laser diodes are attached to the ceramic via a silver filled epoxy utilizing a precision placement machine. Additional capacitors are also placed on the module also using silver filled epoxy as the attachment method. The epoxy is cured through a bake process and then gold wedge bonds are made providing the final electrical connections.

The O to E assembly undergoes much the same process. The PIN detector diodes and amplifier IC are accurately placed and attached using silver filled epoxy. As with the E to O assembly, additional capacitors are placed using silver filled epoxy. The epoxy is cured through a bake process with this assembly as well. After the components have been attached, the part is bonded up using gold wedge bonds. These gold wedge bonds provide all the connectivity from the flexible circuit board to the ceramic board in the case of the E to O assembly.

Optical Alignment

With all the components placed, the modules have the plastic optical assemblies aligned to the detectors or laser depending on the type of module. Once the alignment is complete with optimal O to E or E to O performance, the plastic is glued to the ceramic with a UV cured epoxy. Once in place the epoxy is exposed to ultra violet light to provide an initial quick cure. Additional epoxy is applied to create a fillet between the plastic optic assembly and the ceramic substrate. The module is then baked to cure this additional epoxy.

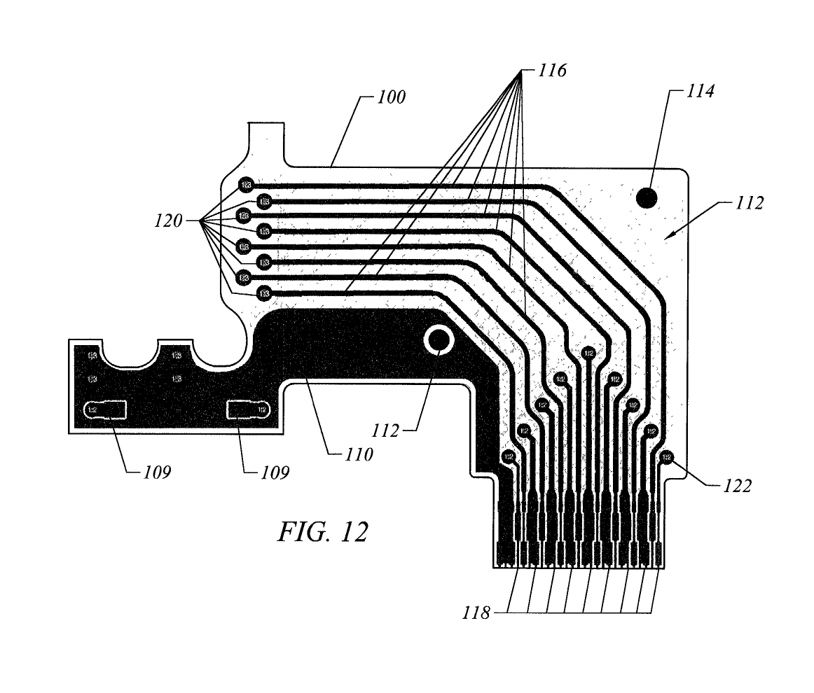

A specific embodiment of an O to E assembly is shown in FIG. 12. The figure shows a top view of the flexible circuit board 100, including the cross hatched ground plane 112. Tooling holes 114 are provided in two places. The 50 ohm transmission lines 116 travel from connection points at the edge of the board to via holes 120, which are used to connect the 50 ohm transmission lines to ceramic traces that are connected to the VCSELs. Ground vias 122 connect the ground lines, in 13 places, on the top of the board to the cross hatched ground on the bottom of the flex board. Also shown are a 5 volt power line 110 and capacitor ground pads 109.

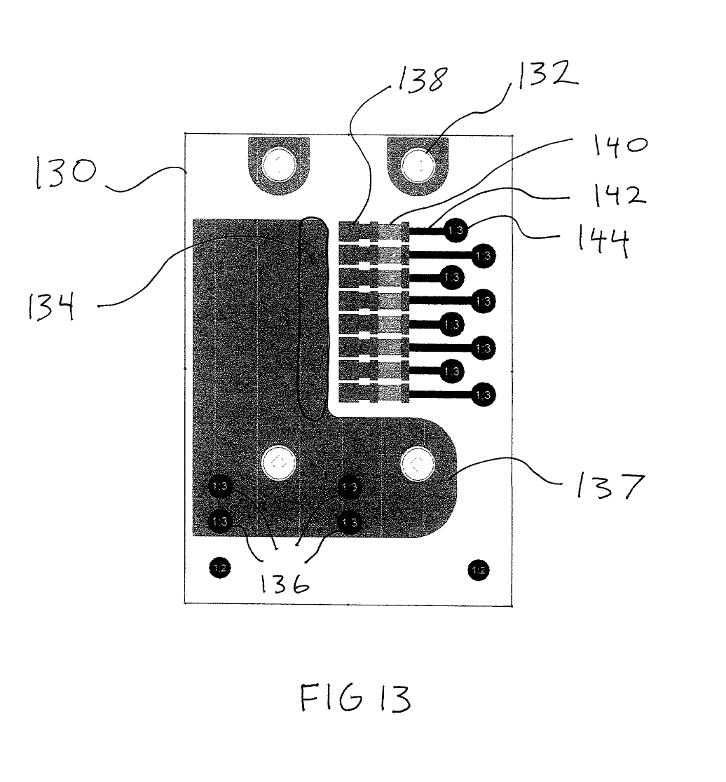

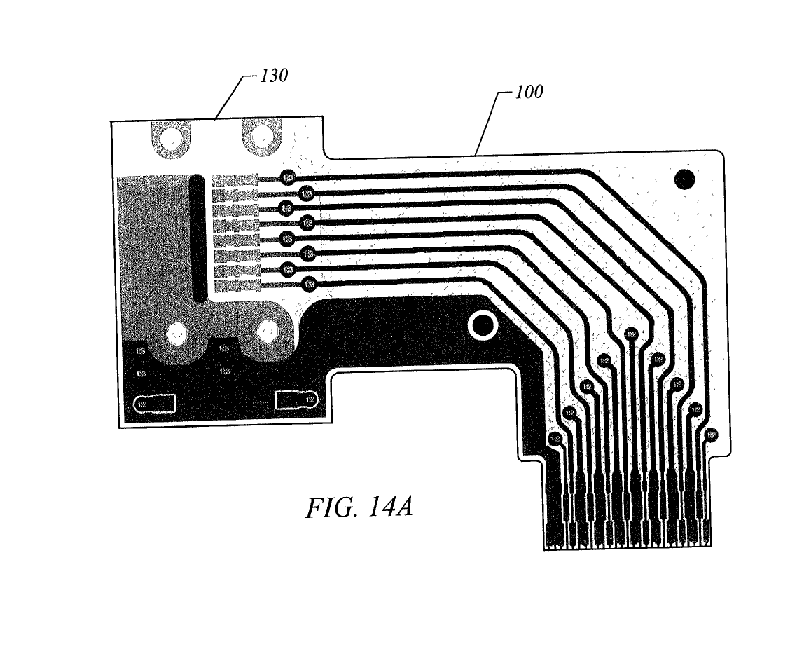

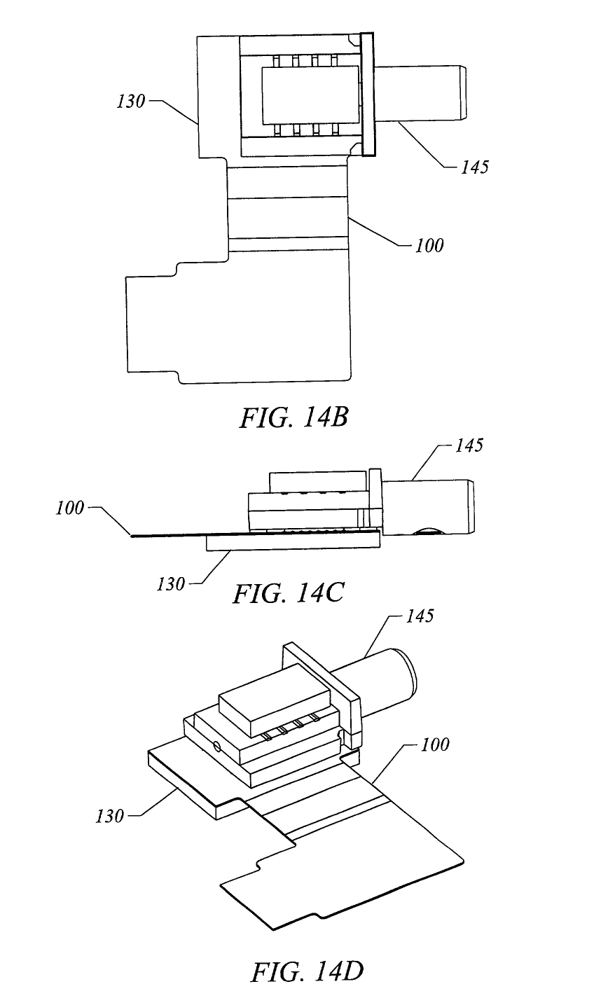

FIG. 13 shows an embodiment of the TX ceramic piece 130 that is to be connected to the flexible circuit board 100 of FIG. 12. Holes 132 are provided in 4 places. A gold metallization bond pad 134 is provided for connecting 5 volts to the VCSEL diodes. Via pads 136 are provided to connect 5 volts from the flexible circuit board 100 to the ceramic piece 130. A layer 137 of PdAg provides a path for 5 volts from via pads 136 to the VCSEL diodes, which are bonded to PdAg metallization pads 138. Thick film resistors 140 are provided next to the VCSEL pads 138. A connection trace 142 of PdAg connects the thick film resistors 140 to the via pads 144. FIG. 14A shows the flexible circuit board 100 connected to the ceramic piece 130. FIG. 14B shows a top view of the plastic pluggable module housing 145 attached to the ceramic piece 130, which is attached to the flexible circuit board 100. FIG. 14C shows a side view of the plastic pluggable module housing attached to the ceramic piece, which is attached to the flexible circuit board. FIG. 14D shows a perspective view of the plastic pluggable module housing attached to the ceramic piece, which is attached to the flexible circuit board. Examples of optical wavelength division multiplexer and demultiplexer configurations that may be included in the plastic pluggable modules of FIGS. 14B-14C are provided in the parent application and in commonly owned U.S. Pat. No. 6,201,908, which has been incorporated herein by reference.

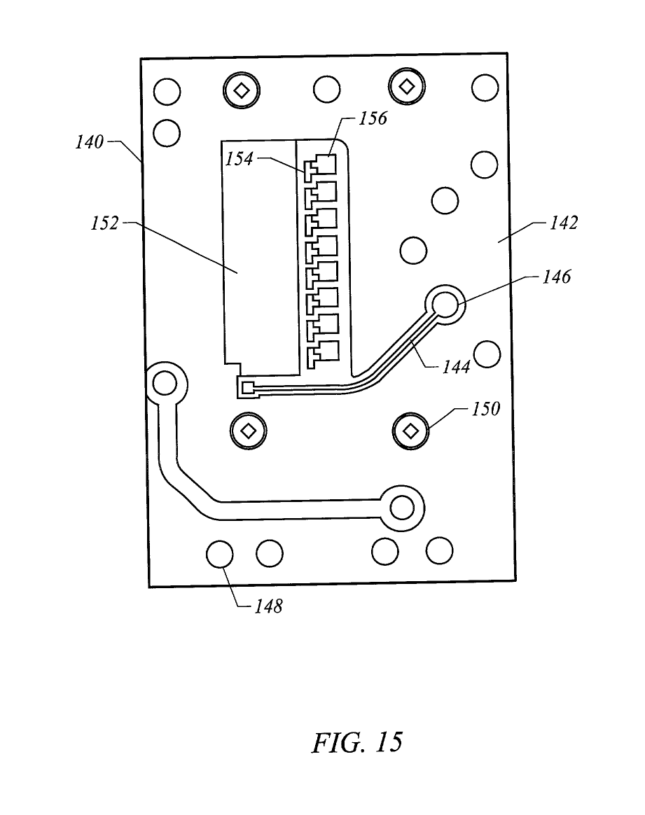

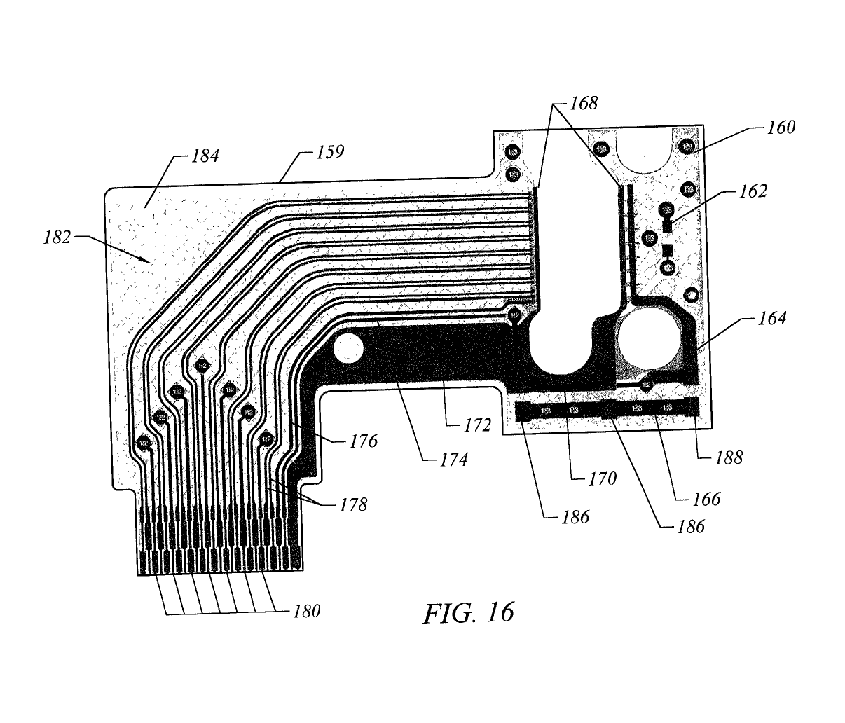

FIG. 15 shows an embodiment of the ceramic piece 140 for use in an Rx assembly. A PdAg metallization layer 142 is provided for the ground signal. A PdAg trace 144 to the bias setting resistor PdAg metallized via pad 146 is provided. PdAg metallization 148 provides a location where the vias on the flexible circuit will connect to ground on the ceramic. The ceramic is provided with 4 holes 150. A gold metallization pad 152 is provided for a trans-impedance amplifier integrated circuit chip. Gold metallized pads 154 are provided for bonding gold wires to the detector diodes. PdAg pads 156 are provided for attaching detector diodes.

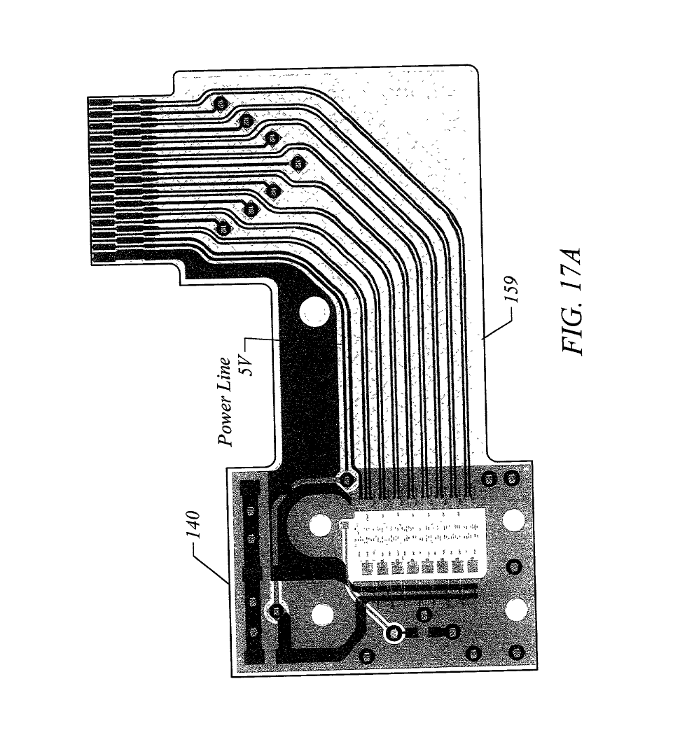

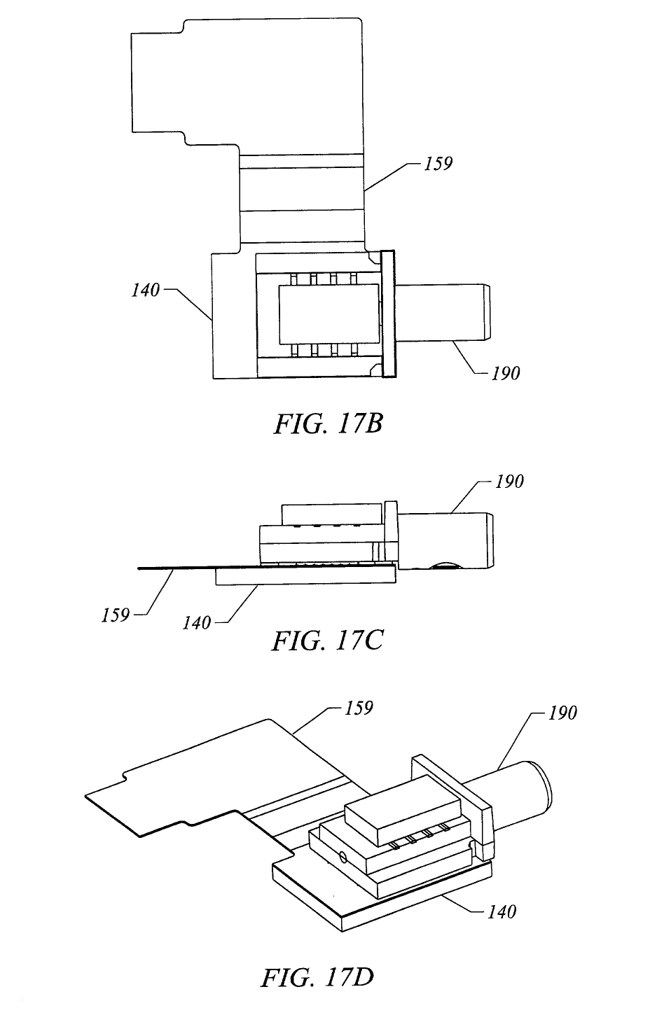

FIG. 16 shows an RX flex circuit 159. Twelve flex via holes 160 provide locations for connecting the ground to the ceramic. Resistor pads 162 are provided for the bias set resistor. Supply rail 164 provides five volts. A ground strip is located at 166. Supply rails 168 provide 1.8 volts. Five volt supply trace 170 is provided on the bottom of the flex board. A supply trace 172 for 1.8 volts and another supply trace for 5 volts 174 are both provided on the top of the flex board. A control line trace 176 is provided for the RX circuit. Transmission lines 178 of 75 ohms are provided. Cross hatching 182 of the ground plane is located on the back of the flex board. Tooling holes 184 are located in the flex board. The pad locations 186 are shown for capacitors from the 1.8 volt supply to ground. The pad locations 188 are shown for capacitors from the 5 volt supply to ground. FIG. 17A shows the ceramic piece 140 attached to the flexible circuit 159. FIG. 17B shows a top view of a plastic pluggable module 190 attached to a ceramic piece 140, which is attached to a flexible circuit 140. FIG. 17C shows a side view of a plastic pluggable module attached to a ceramic piece, which is attached to a flexible circuit. FIG. 17D shows a perspective view of a plastic pluggable module attached to a ceramic piece, which is attached to a flexible circuit. Examples of optical wavelength division multiplexer and demultiplexer configurations that may be included in the plastic pluggable modules of FIGS. 17B-17C are provided in the parent application and in commonly owned U.S. Pat. No. 6,201,908, which has been incorporated herein by reference.

It should be recognized that specific location for placement of the components, traces, etc., on the circuit board and the ceramic could be varied without departing from the scope of this invention.

Electrical to Optical (E to O) conversion circuits require that the transmission of the electrical signals to the converter circuits be accomplished with minimal loss and with good signal integrity. Reducing signal loss is achieved by reducing reflections as well as by lowering absorptive loss. Preventing cross talk between adjacent signal lines, as well as by reducing ringing and standing waves that result from signal reflections optimizes signal integrity.

Achieving good signal integrity and low signal loss typically requires creating a real transmission line impedance with the capacitive and inductive effects of the transmission line conductor cancelled out (i.e., no imaginary component to the transmission line impedance). In addition, optimal signal integrity and signal transmission requires that the source and load impedances presented to the transmission line match the impedance of the transmission line.

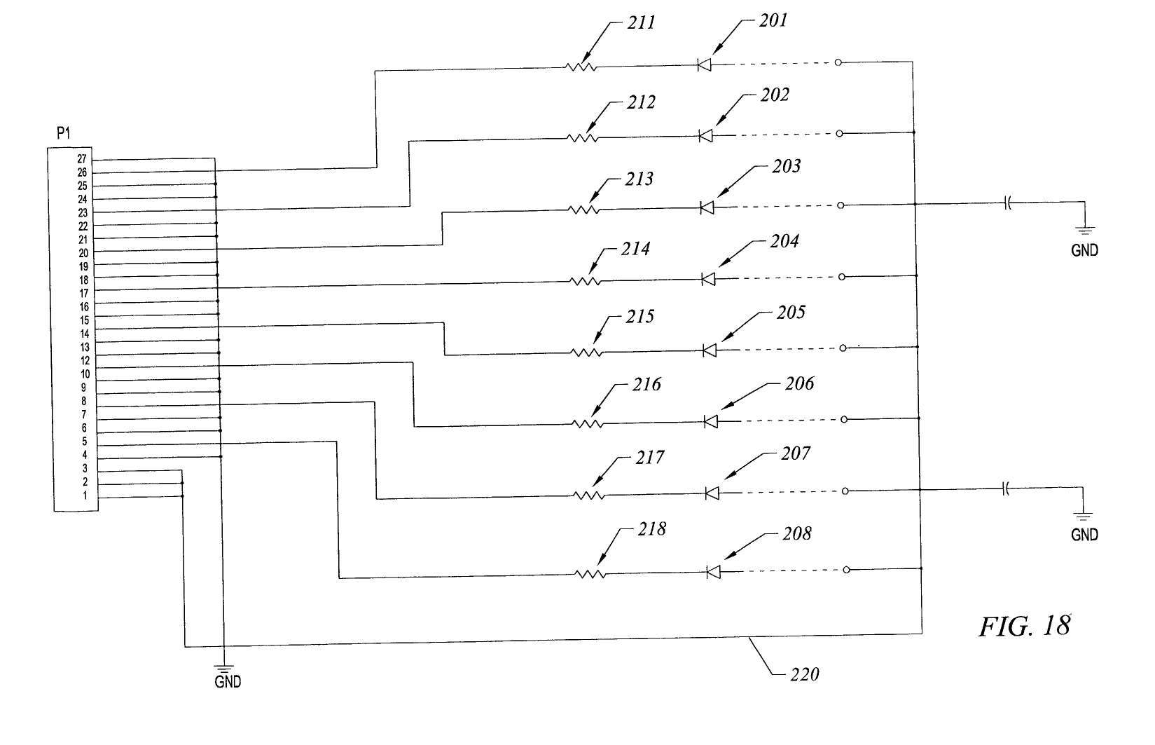

O to E conversion is often accomplished using a vertical cavity surface emitting laser (VCSEL) diode. As shown in FIG. 18, this particular design utilizes VCSELs 201-208 in the 780 to 865 nm wavelength range. These particular VCSELs have a nominal impedance of 25 ohms. In order to achieve a well matched 50 ohm transmission line and load circuit, a 25 ohm impedance resistor (211-218) is placed in series with and in close proximity to each VCSEL. The 25 ohms of the VCSEL plus the 25 ohms of a passive resistor creates a 50 ohm load that provides the lowest loss, greatest power transfer match to the 50 ohm transmission line.

Since the VCSEL is a current mode device and the laser driver circuitry is operating as a current source off of a fixed supply rail 220 of 5V, there is no additional total power loss with the use of the matching resistor. Power that would have been dissipated in the laser driver circuit if there were no resistor is now simply dissipated in the resistor.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. An optical to electrical or electrical to optical conversion assembly, comprising:
a substrate having a surface onto which components of said conversion assembly are attached; and
a flexible circuit operatively and electrically attached to said surface.

2. The conversion assembly of claim 1, wherein said components are selected from the group consisting of optical components and electrical components.

3. The conversion assembly of claim 1, wherein said conversion assembly is selected from the group consisting of an optical to electrical conversion assembly (OECA) and an electrical to optical conversion assembly (EOCA).

4. The conversion assembly of claim 3, wherein said conversion assembly comprises an optical wavelength division multiplexer and demultiplexer for single-mode or multi-mode fiber optic communication systems.

5. The conversion assembly of claim 3, wherein said surface comprises a low coefficient of thermal expansion.

6. The conversion assembly of claim 5, wherein said surface comprises a thermal conductivity rating of about at least 25 W/m K.

7. The conversion assembly of claim 6, wherein said surface comprises a ceramic material.

8. The conversion assembly of claim 7, wherein said ceramic material is selected from the group consisting of BeO, AIN, or Al₂O₃.

9. The conversion assembly of claim 8, wherein said components are attached to said surface utilizing a thick film process to deposit metal on said substrate for attachment of optical conversion circuits, routing of signals and gold bond wire attachment.

10. The conversion assembly of claim 8, wherein said substrate undergoes a subtractive etch process and then is copper plated.

11. The conversion assembly of claim 8, wherein said conversion assembly comprises said OECA, wherein electrical connections are made from said flexible circuit to said components with gold bond wire.

12. The conversion assembly of claim 8, wherein said conversion assembly comprises said EOCA, wherein electrical connections are made from said flexible circuit to said components with solder.

13. The conversion assembly of claim 1, wherein said flexible circuit is electrically attached to at least one component of said components to form an operation circuit, wherein said operation circuit comprises means for achieving low loss transmission of an electrical signal propagating on said operation circuit.

14. The conversion assembly of claim 13, wherein said means for achieving low loss transmission comprises a transmission media that is selected from the group consisting of coaxial cable, microstrip and stripline.

15. The conversion assembly of claim 14, wherein said transmission media comprises a transmission frequency within a range from 1 MHz to 20 GHz.

16. The conversion assembly of claim 13, wherein said means for achieving low loss transmission comprises a waveguide transmission media comprising a transmission frequency of at least about 500 MHz.

17. The conversion assembly of claim 13, wherein said means for achieving low loss transmission of an electrical signal propagating on said operation circuit are selected from the group consisting of reducing reflections, lowering absorptive loss, preventing cross talk between adjacent signal lines, reducing ringing and reducing standing waves that result from signal reflections.

18. The conversion assembly of claim 13, wherein said means for achieving low loss transmission comprises providing said operation circuit with a transmission line having a real transmission line impedance wherein capacitive and inductive effects of the conductor of said transmission line are cancelled out, wherein said transmission line has no imaginary impedance component.

19. The conversion assembly of claim 13, wherein said operation circuit comprises a transmission line, wherein a source and a load are operatively connected to said transmission line, wherein said source and said load each present an impedance to said transmission line that match the impedance of said transmission line.

20. The conversion assembly of claim 1, wherein said flexible circuit comprises a flexible layer.

21. The conversion assembly of claim 20, wherein a crosshatched ground plane is attached to said flexible layer.

22. The conversion assembly of claim 21, further comprising a conductive signal layer attached to said flexible layer on the opposite side of said flexible layer with respect to said cross hatched ground plane.

23. The conversion assembly of claim 22, further comprising an outer solder mask layer on said cross hatched ground plane and another outer solder mask layer on said conductive signal layer.

24. The conversion assembly of claim 20, wherein said flexible layer comprises polyimide.

25. The conversion assembly of claim 20, wherein said flexible layer comprises polyimide, wherein said polyimide is about 0.0020 inches thick.

26. The conversion assembly of claim 23, wherein at least one solder mask layer comprises a liquid photo imageable solder mask.

27. The conversion assembly of claim 13, wherein said operation circuit comprises a transmission line terminated with a VCSEL diode and series resistor such that the nominal impedance of said transmission line matches the combined impedance of said VCSEL and said series resistor.

28. The conversion assembly of claim 27, wherein said VCSEL is a current mode device and is powered by laser driver circuitry operating as a current source off of a fixed supply rail of 5V, wherein there is no additional total power loss with the use of said matching resistor, wherein power that would have been dissipated in the laser driver circuit if there were no matching resistor is now dissipated in said resistor.

29. A method of fabricating a ceramic substrate for use in an optical to electrical or electrical to optical conversion assembly, comprising:
providing a sheet of ceramic material;
lapping said sheet down to a desired thickness of about 0.035 inches;
drilling all necessary holes in said sheet;
cleaning and pre-firing said sheet in a convection oven that slowly ramps the material up to 850 to 900 degrees C.;
applying a PdAg paste to said sheet;
baking said sheet at 100 to 150 degrees C. to remove the solvents from said paste;
firing said sheet in a convection oven that slowly ramps the temperature to between 850 and 900 degrees C. to anneal said paste;
allowing said sheet to cool;
printing gold pads and traces onto said sheet;
baking said sheet at 100 to 150 degrees C. to remove the solvents from said gold pads and traces;
firing said sheet in a convection oven that slowly ramps the temperature to between 850 and 900 degrees C. to anneal said gold pads and traces;
depositing a resistive paste is said ceramic surface in the required geometry; and
baking and firing said resistive paste.

30. A method of fabricating a flexible high speed transmission line for use in an optical to electrical or electrical to optical conversion assembly, comprising:
providing a sheet of about 0.002 inch thick polyimide material;
depositing and annealing copper on both sides of said sheet;
cutting all the required vias and holes in said sheet;
plating said sheet with copper to fill in said vias and holes;
strengthening the connections of said vias with an additional electroplated copper plating sequence;
applying dry film photoresist to both sides of said sheet;
applying negative image films of desired copper traces and cross hatched ground to both sides of the panel;
removing the resist from the areas where the copper is to be removed;
placing said sheet in an alkaline etching bath where unwanted copper is removed from said sheet and the remaining photoresist is then stripped away leaving copper only where traces and cross hatched ground are desired;
coating said sheet with liquid photoimageable solder mask;
placing said sheet in an oven at about 170 to 180 degrees C. for about 15 minutes;
placing a negative image film of a solder mask layer on the top and bottom of said sheet and exposing said sheet to ultra violet light, wherein the areas exposed to the light are polymerized and become resistant to the developer;
placing said sheet in a developer bath, wherein the solder mask is removed from those areas of the board that were not exposed to the ultra violet light;
baking said sheet at about 300 degrees C. for about 1 hour to completely cure said solder mask layers;
plating the exposed copper on said sheet using an electroless Nickel plating process; and
plating said sheet with gold.
